(19) United States
(12) Patent Application Publication
(10) Pub. No.: US 2022/0268651 A1
(43) Pub. Date: Aug. 25, 2022

(54) Dynamometer For Use With Rail Equipment, And Systems And Methods Of Using Same

(71) Applicant: Diversified Products, LLC, Omaha, NE (US)

(72) Inventors: Michael A. Rau, Omaha, NE (US); Zach McVey, Omaha, NE (US); Jeff T. Bartek, Omaha, NE (US)

(21) Appl. No.: 17/182,126

(22) Filed: Feb. 22, 2021

(51) Int. Cl. G01L 3/24; G01L 5/00; B61L 27/00

(52) U.S. Cl. CPC G01L 3/245; G01L 5/00; B61L 27/0055

(57) ABSTRACT

A dynamometer can be used with rail equipment having two pairs of drive wheels. The dynamometer can comprise first and second wheel engagement assemblies, each comprising a frame, a first pair of dynamometer wheels that are spaced relative to a first horizontal dimension, and a second pair of dynamometer wheels that are spaced relative to the first horizontal dimension. The first and second pairs of dynamometer wheels can be spaced relative to a second horizontal dimension. The first pair of dynamometer wheels and second pair of dynamometer wheels can cooperate to define opposing wheel engagement receptacles. A hydraulic motor can couple to the first plurality of support wheels and can be configured to receive a power and an associated torque from a respective pair of the drive wheels of the rail equipment. The first and second wheel engagement assemblies can be movable relative to each other along the second dimension.

### FIELD

This disclosure is generally related to dynamometers and, in particular, to dynamometers for rail equipment.

### BACKGROUND

Dynamometers are devices for simultaneously measuring the torque and rotational speed of an engine or motor to determine an instantaneous power. Presently, no solution exists for engaging a dynamometer with rail equipment, such as, for example, rail-bound or hi-rail equipment (e.g., maintenance of way, or MOW equipment). This makes diagnostics for the rail equipment difficult or impossible. Accordingly, a dynamometer for use with rail equipment is desirable.

### SUMMARY

Described herein, in one aspect, is a dynamometer for use with rail equipment having two pairs of drive wheels. The dynamometer can comprise first and second wheel engagement assemblies, each comprising a frame and a first pair of dynamometer wheels that are spaced relative to a first horizontal dimension and rotatably supported on the frame about a first rotational axis that extends parallel to the first horizontal dimension. A second pair of dynamometer wheels can be spaced relative to the first horizontal dimension and rotatably supported on the frame about a second rotational axis that is parallel to the first horizontal axis and offset from the first horizontal axis relative to a second horizontal dimension that is perpendicular to the first horizontal dimension. The first pair of dynamometer wheels and second pair of dynamometer wheels can cooperate to define opposing wheel engagement receptacles. A hydraulic motor can be coupled to the first pair of dynamometer wheels. The hydraulic motor can be configured to receive a power and an associated torque from a respective pair of the drive wheels of the rail equipment. The first and second wheel engagement assemblies can be configured to move relative to each other along the second dimension.

### DESCRIPTION OF THE DRAWINGS

FIG. 1 is perspective view of a dynamometer for rail equipment as disclosed herein, wherein the dynamometer has first and second wheel engagement assemblies that are spaced relative to each other by a first spacing.

FIG. 2 is a detail perspective view of a portion of the dynamometer of FIG. 1.

FIG. 3 is a perspective view of the dynamometer of FIG. 1, wherein the first and second wheel engagement assemblies are spaced relative to each other by a second spacing.

FIG. 4 is a detail perspective view of a portion of the dynamometer of FIG. 3.

FIG. 5 is a perspective view of another dynamometer in accordance with embodiment disclosed herein.

FIG. 6 is a block diagram of a computing device and associated operating environment for use with the dynamometer as disclosed herein.

FIG. 7 is an exemplary hydraulic schematic diagram of at least portion of a hydraulic system in accordance with embodiments disclosed herein.

FIG. 8 is a block diagram illustrating exemplary control logic of the dynamometer as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a”, “an”, and “the” include plural referents unless the context clearly dictates otherwise. For example, use of the term “a support wheel” can refer to one or more of such support wheels.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about” or “substantially,” it is contemplated that values within up to 15%, up to 10%, up to 5%, or up to 1% (above or below) of the particularly stated value or characteristic can be included within the scope of those aspects.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

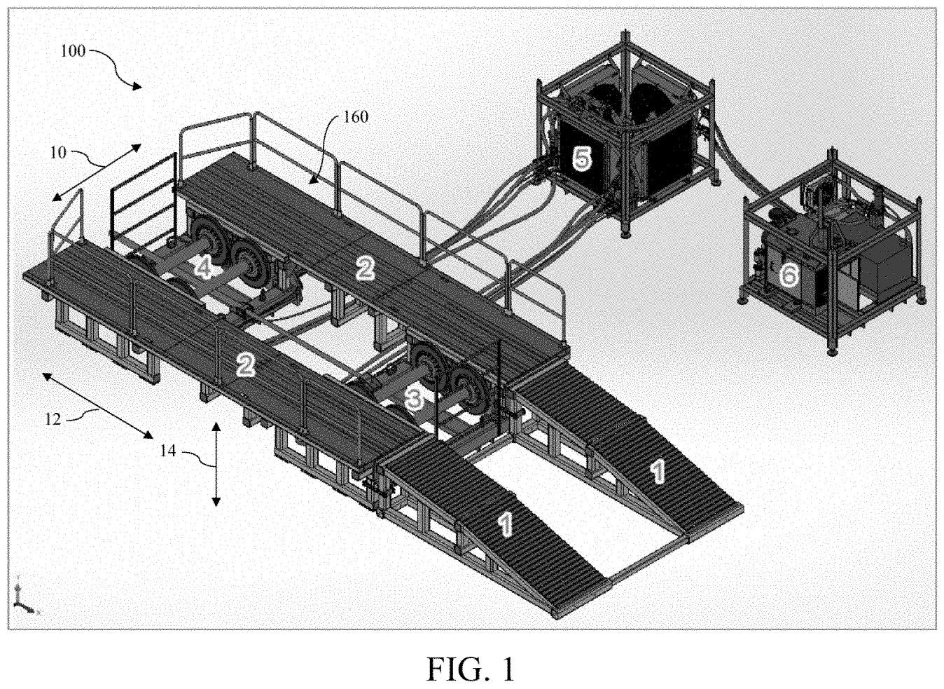

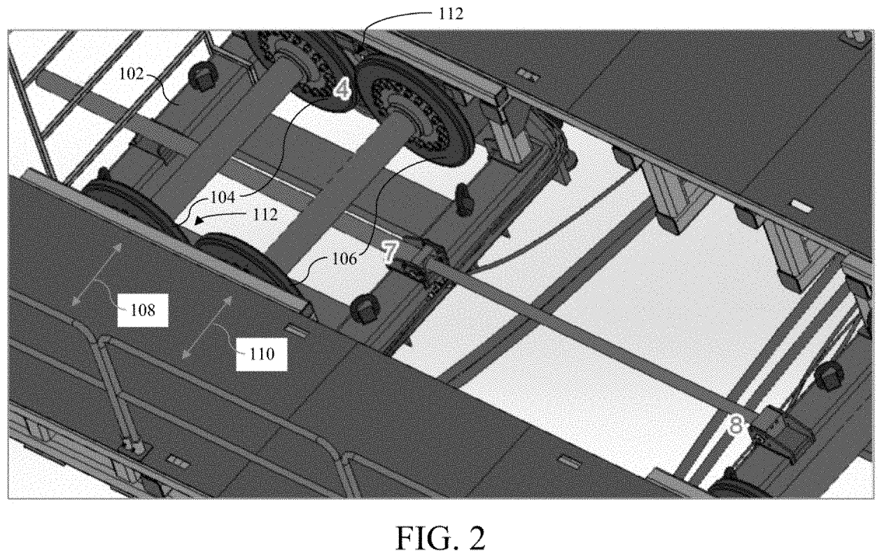

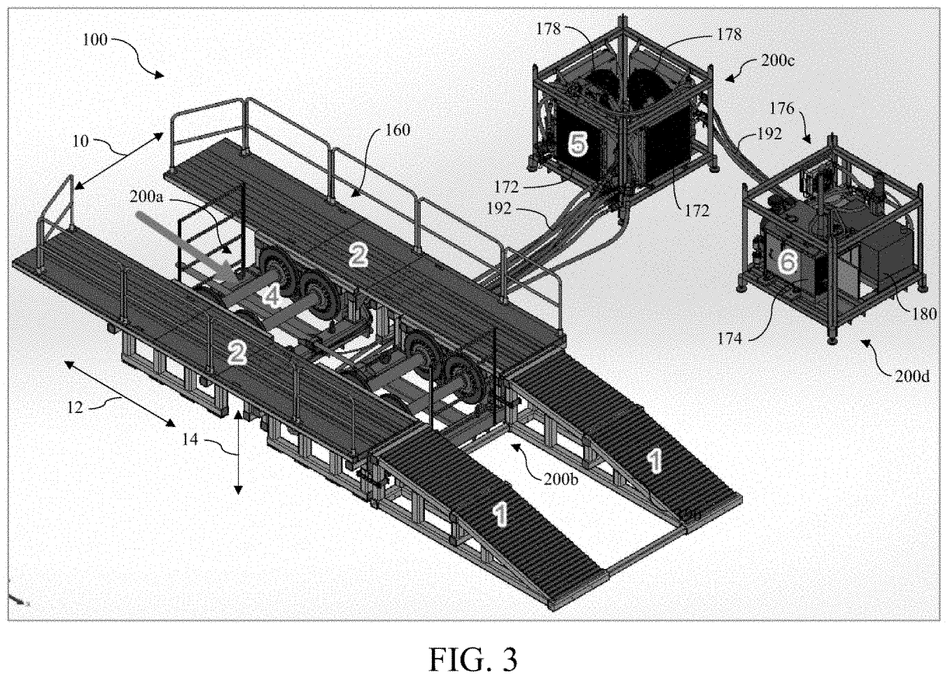

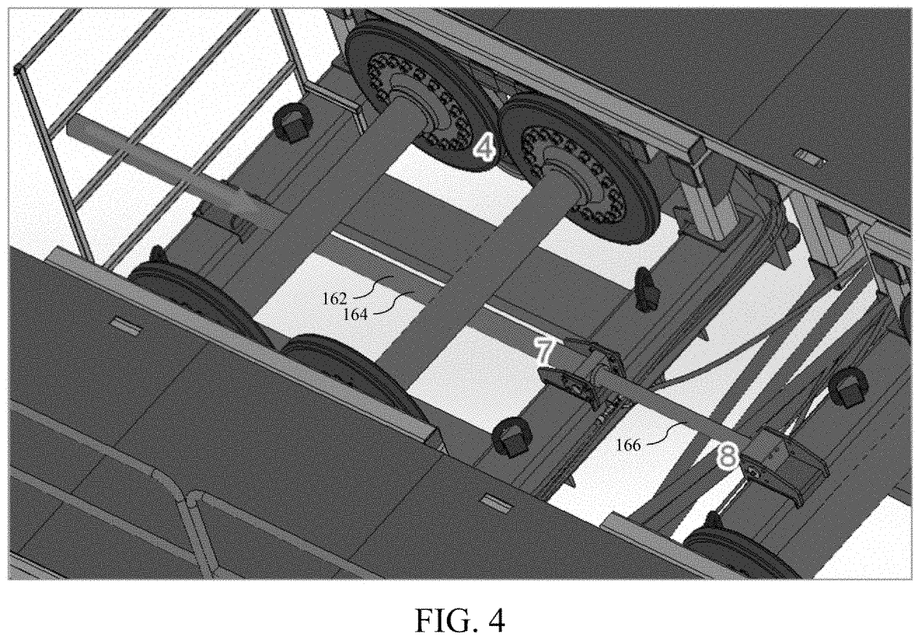

Disclosed herein are devices and systems for testing rail equipment. In some aspects, the rail equipment can have two pairs of wheels. The two pairs of wheels can optionally both be pairs of drive wheels. The rail equipment can optionally be MOW equipment. Referring to FIGS. 1-4, a dynamometer 100 can comprise first and second wheel engagement assemblies 3, 4. The first and second wheel engagement assemblies 3,4 can each comprise a frame 102, a first pair of dynamometer wheels 104, and a second pair of dynamometer wheels 106. The wheels of the first pair of dynamometer wheels 104 can be spaced from each other relative to a first horizontal dimension 10. The first pair of dynamometer wheels 104 can be rotatably supported on the frame 102 about a first rotational axis 108 that extends parallel to the first horizontal dimension 10. The second pair of dynamometer wheels 106 can be rotatably supported on the frame 102 about a second rotational axis 110 that extends parallel to the first horizontal dimension 10. The first rotational axis 106 can be offset from the second horizontal axis 108 relative to a second horizontal dimension 12 that is perpendicular rot the first horizontal dimension 10.

The first and second pairs of dynamometer wheels 104, 106 can cooperate to define opposing wheel engagement receptacles 112. For example, the first pair of dynamometer wheels 104 can be spaced from the second pair of dynamometer wheels 106 relative to the second horizontal dimension 12 so that the wheel of the rail equipment biases against a respective dynamometer wheel of each of the first and second pairs of dynamometer wheels at a respective contact area (i.e., two contact areas per wheel of the rail equipment). It is contemplated that the contact areas (of the dynamometer wheels) can provide sufficient frictional engagement so that movement of the drive wheels of the rail equipment causes corresponding movement of the dynamometer wheels with no slippage or substantially no slippage therebetween. That is, the static and rolling friction between the wheels of the rail equipment and the dynamometer wheels can be sufficient so that the torque of the rail equipment cannot overcome said static and rolling friction. Optionally, the weight of the rail equipment can be distributed evenly, or substantially evenly, across each of its wheels.

The opposing wheel engagement receptacles 112 can be spaced to permit concurrent receipt of the respective pairs of drive wheels of the rail equipment. For example, the wheel engagement receptacles can be spaced to simultaneously receive drive wheels that are configured for a selected track gauge (e.g., 56.5 inch track gauge). In exemplary aspects, a first wheel engagement receptacle 112 can be at least partially defined by a first wheel of the first pair of dynamometer wheels 104 and a first wheel of the second pair of dynamometer wheels 106 while a second wheel engagement receptacle can be at least partially defined by a second wheel of the first pair of dynamometer wheels and a second wheel of the second pair of dynamometer wheels.

Optionally, each wheel of the first and second pairs of dynamometer wheels of each of the first and second wheel engagement assemblies can define a respective convex circumferential surface that is receivable into a corresponding groove of a wheel of the rail equipment.

Optionally, the first and second wheel engagement assemblies 3,4 can collectively be able to support at least 150,000 pounds during testing.

In some aspects, the first and second wheel engagement assemblies 3, 4 can comprise at least one anchor 124. For example, each wheel engagement assembly can comprise a pair of anchors 124 on each side of the wheel engagement assembly. A first anchor of each pair can be forward of the first pair of dynamometer wheels, and the second anchor of each pair can be rearward of the second dynamometer wheels. The chain can comprise, for example, a tie down ring that defines an opening. The tie down ring can optionally be pivotably coupled to the frame. A chain, cable, rope, etc. can extend between each of the pairs of anchors 124 and over a portion of the rail equipment to retain the rail equipment on the wheel engagement assembly. Optionally, the chain, cable, rope, etc., can extend through the opening of the tie down ring or couple to the tie down ring via a hook.

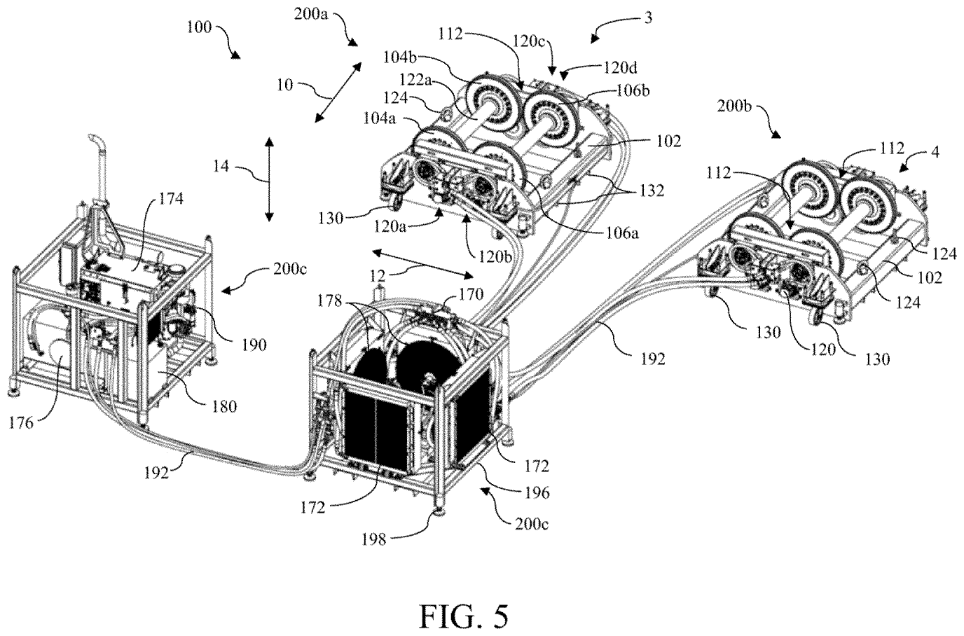

Referring to FIG. 5, at least one motor 120 can be coupled to at least one wheel of the first and second pairs of dynamometer wheels 104, 106 (e.g., one of the wheels of the first pair of dynamometer wheels 104). Optionally, each of the first and second wheel engagement assemblies 3,4 can comprise a first motor 120a, a second motor 120b, a third motor 120c, and a fourth motor 120d. The first motor 120a can couple to a first dynamometer wheel 104a of the first pair of dynamometer wheels 104; the second motor 120b can couple to a first dynamometer wheel 106a of the second pair of dynamometer wheels 106; die third motor 120c can couple to a second dynamometer wheel 104b of the first pair of dynamometer wheels 104; and the fourth motor 120d can couple to a second dynamometer wheel 106b of the second pair of dynamometer wheels 106. Optionally, the dynamometer wheels can couple to the respective motors via a chain and sprocket coupling. Each of the motors 120a,b,c,d can be hydraulic motors. It is contemplated that hydraulic motors can be compact, thereby lowering weight and reducing spatial dimensions, and can transfer a large power density at lower speeds to a common manifold, thereby allowing a simplified control system as compared to electric motors. However, in further embodiments, dynamic loading can be provided by electric motors, friction drums, etc.

In further optional aspects, the second pair of dynamometer wheels 106 can be freely rotating. Accordingly, a respective motor 120a, 120b can respectively couple to the first and second dynamometer wheels 104a,b of each wheel engagement assembly, and the third and fourth motors 102c,d can be omitted. In still further aspects, an axle 122a between the first pair of dynamometer wheels 104 can fixedly couple the dynamometer wheels to one another so that rotation of one causes corresponding rotation of the other (e.g., via a press fit mechanical locking coupling). Likewise, an axle 122b between the second pair of dynamometer wheels 106 can fixedly couple the dynamometer wheels to one another so that rotation of one causes corresponding rotation of the other. Accordingly, in some optional aspects, each wheel engagement assembly can comprise only a single motor. However, for reasons stated herein, it can be beneficial to have four, or at least two, motors per engagement assembly.

In some optional aspects, the motor(s) of one of the first wheel engagement assembly 3 or the second wheel engagement assembly 4 can be omitted. Such an embodiment can be used to test rail equipment having only one driven axle or one pair of drive wheels. However, it is further contemplated that the hydraulic circuits of the first and second wheel engagement assemblies 3,4 can be isolated from each other so that embodiments having motors on each of the wheel engagement assemblies can be used to test such rail equipment having only one driven axle or one pair of drive wheels.

It is contemplated that using four hydraulic motors (or at least four motors) per wheel engagement assembly can be advantageous. For example, because of the speed and torque during testing, fewer than four motors, and especially a single motor, can be insufficient to generate the necessary hydraulic displacement ardor pressure ratings. With four motors, power transferred to the rail dyno can be divided by a factor of four, allowing for smaller mechanical connections (e.g., chains and sprockets) as well as readily available hydraulic motors. The hydraulic motors can couple to a manifold via hoses (as compared to the mechanical connection required for a single motor. Further, with four motors, the first and second wheel engagement assemblies 3, 4 can be symmetric, simplifying design and assembly. As another advantage, wheel wear can cause the rotational speeds to deviate by a small percentage from axle to axle. Mechanically connected axles (e.g., coupling the axles 122a,122b) would require equivalent rotation speed, thereby resulting in mechanical lock or excessive wheel slippage or wear/galling. Hydraulically connected axles allows the deviation/slip to happen via normal hydraulic flow instead of mechanical wear.

The motors 120 can be configured to receive a power and an associated torque from a respective drive wheel of the rail equipment. For example, at least one of the motors 120 can comprise a speed sensor (e.g., a tachometer). Using the speed of the motor and knowing the (volumetric) hydraulic displacement per revolution, the hydraulic flow rate per wheel engagement assembly can be calculated (e.g., rotations per minute multiplied by hydraulic displacement per revolution can provide displacement per minute). At least one sensor can measure the hydraulic pressure. Optionally, each the hydraulic pressure can be measured for each motor. The power can then be determined as a product of the hydraulic pressure and the hydraulic flow rate (e.g., power=hydraulic pressure multiplied by hydraulic flow rate multiplied by the motor efficiency, the latter being a known quantity that is a property of the motor). It is further contemplated that the dynamometer 100 can be calibrated through testing and tuning to provide a window of error (e.g., determine a margin of error via interpolation).

It is contemplated that different types of rail equipment can have different spacing between the front and rear wheels of the rail equipment. The first and second wheel engagement assemblies 3,4 can be movable relative to each other along the second dimension 12. In this way, the dynamometer 100 can be configured to adapt to different spacing between the front and rear wheels of the rail equipment.

In some optional aspects, as shown in FIG. 5, the frames 102 can define channels that are configured to receive forks of a fork lift or floor jack for positioning the wheel engagement assemblies. The channels can optionally be on an underside of the frame. For example, in some optional aspects, the frame can comprise U-channel members 132 (e.g., a pair of U-channel members) that extend horizontally on an underside of the frame with their openings facing downwardly. Thus, the U-channel members 132 can form the channels that receive the forks of the fork lift or floor jack.

The first and second wheel engagement assemblies 3,4 can comprise one or more support wheels 130 (e.g., casters) that are coupled to the frame 102. In this way, the first and second wheel engagement assemblies can be movable with respect to each other relative to the first horizontal dimension 10 and the second horizontal dimension 12. This can be advantageous so as to allow the first and second wheel engagement assembles 3,4 to move to align with the wheels of the rail equipment (both rotationally about a vertical axis 14 and laterally in the first and second horizontal dimensions 10,12) as the rail equipment is lowered onto the wheel engagement assemblies with the wheels of the rail equipment being received within the wheel engagement receptacles. Accordingly, an operator can roughly position the wheel engagement assemblies, and the weight of the rail equipment can further cause self-alignment of the wheel engagement assemblies.

The support wheels 130 can be movably coupled to the frame relative to the vertical axis 14 and can be spring biased downwardly relative to the frame. Accordingly, as the rail equipment is lowered onto the wheel engagement assemblies, the weight of the rail equipment can cause the frame 102 to lower (relative to the casters, due to the spring bias) until the frame 120 itself (instead of the support wheels 130) rests on the ground. Optionally, the springs can comprise gas springs. Air can be released from pressure relief valves as the gas springs are compressed.

Referring to FIGS. 1-4, in further optional aspects, the first and second wheel engagement assemblies 3,4 can be positioned below a support structure 160. The support structure 160 can comprise opposing ramps 1 and opposing platforms 2 that are spaced relative to the first horizontal dimension 10. In some optional aspects, the first and second wheel engagement assemblies 3,4 can be coupled to the support structure 160. In some optional aspects, the first wheel engagement assembly 3 can be fixedly coupled to the support structure 160, and the second wheel engagement assembly 4 can be movably coupled to the support structure 160. For example, the second wheel engagement assembly 4 can be guided by the support structure 160 or by a floor channel (not shown). Optionally, a cylinder 162 (e.g., a hydraulic or pneumatic cylinder) can move the second wheel engagement assembly 4 relative to the first wheel engagement assembly 3 along the second horizontal dimension 12. For example, the cylinder 162 can comprise a cylinder bore 164 that is coupled to the second wheel engagement assembly 4 via a cylinder bore mount 7 and a cylinder rod 166 that is coupled to the first wheel engagement assembly 3 via a cylinder rod mount 8. Accordingly, movement of the cylinder rod 166 relative to the bore 164 (e.g., via application of pneumatic or hydraulic pressure to a piston within the bore) can cause the second wheel engagement assembly 4 to move toward and away from the first wheel engagement assembly 3. In this way, the dynamometer 100 can be configured for use with rail equipment having different wheel spacing.

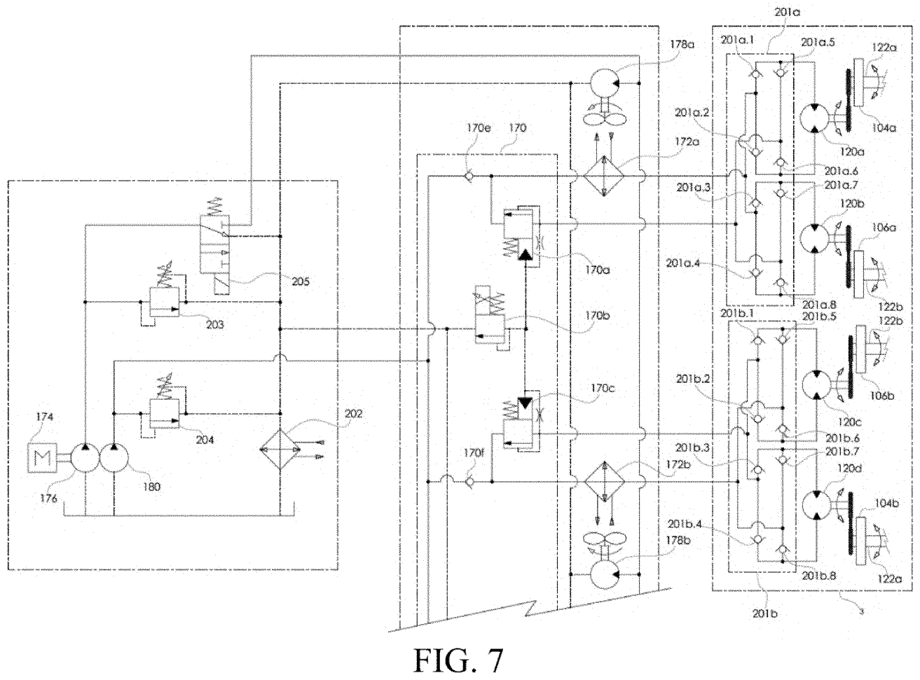

The motors 120 can generate fluid flow through one or more hydraulic circuits. Each hydraulic circuit can comprise at least one hydraulic pressure control valve 170 that is configured to induce pressure in the circuit. The computing device 1001 can calculate a required circuit current to induce the desired pressure load. Referring also to FIG. 7, the first and second wheel engagement assemblies 3 and 4 can have individual pressure control valves, so they can electronically operate at different pressure loads or be electronically controlled at the same pressure. Accordingly, it is contemplated that the pressure control valve 170 can be embodied as a manifold assembly comprising a pressure control valve 170a and a pressure control valve 170b that can operate assemblies 3 and 4 respectively. The pressure control valves 170a,b can be electronic proportional pressure control valves.

In some aspects, the hydraulic power in the circuit(s) (from the motors 120) can be converted into heat as a function of a pressure drop induced by the control valves 170. The control valve 170 can be divided into two (optionally, identical) portions. Each portion can control one of the first or second wheel engagement assemblies 3, 4. As shown in FIG. 7, one portion of the pressure control valve 170 can operate with the first wheel engagement assembly 3. Valve 170b can be the electronic control valve that controls the pilot pressure for valves 170a and 170c. A valve 170a can increase or decrease the pressure drop of the motor return flow from a valve 201a. Valves 170e and 170f can maintain charge pressure and allow charge flow from the pump 180 to enter the circuit to make up for flow losses to tank. The valve 201a can comprise check valves 201a.1-4 that resolve motor direction change and directs charge flow from pump 180 to the motors 120a, 120b. Check valves 201a.5-8 can resolve motor direction change and direct the hydraulic flow from the motors 120a, 120b to the load control valve 170a.

The dynamometer 100 can comprise at least one heat exchanger 172 (e.g., four heat exchangers—170a,b,c,d—as shown) that are configured to dissipate the heat from the hydraulic pressure control valves 170.

In some aspects, the dynamometer 100 can comprise an engine 174. The engine can provide power to a first hydraulic pump 176 that is configured to hydraulically drive thus 178 that cool the heat exchangers 172. As shown in FIG. 7, the pump 176 can be protected via a hydraulic relief 203. The valve 205 can directs hydraulic flow to the fan motors 178. In some optional aspects, the hydraulic motors 120 can require a hydrostatic charge pressure that prevents motor damage. The hydrostatic charge pump can supply and maintain a minimum hydraulic pressure at a specific hydraulic component to prevent a condition called hydraulic cavitation (a strong hydraulic vacuum). Hydraulic cavitation can cause significant wear and damage to the component. Accordingly, in some aspects, the engine 174 can power a secondary hydraulic pump 180 that provides hydraulic flow and pressure to maintain the charge pressure. The hydraulic pump 18 can be hydraulically protected via a hydraulic pressure relief valve 204. The pressure relief valve 204 can further regulate motor charge pressure. The dynamometer 100 can comprise an emergency stop actuator 190 (e.g., a button) that shuts down the engine 174 and disables system control pressures.

It is contemplated that the various hydraulic circuits can comprise hoses 192 that communicate hydraulic fluid therethrough. For example, the motors can be in communication with the pressure control valves 170 via hoses 192. Fluid can return to a hydraulic fluid tank through the heat exchanger 202. The heat exchanger 202 can be controlled by a fan (e.g., an electric fan). The fan can optionally be triggered by a temperature switch.

In some aspects, a computing device 1001 can be configured to receive and process data from the dynamometer 100. For example, the computing device 1001 can be configured to receive speed data from the speed sensor and pressure data from the pressure sensor(s). The computing device can further be configured to process the speed and pressure data to determine a power output from the rail equipment, as further described herein. Further, the computing device 1001 can comprise a display or other output device (e.g., a printer) that is configured to output various data (e.g., power data). Optionally, the computing device can comprise an input device, as further described herein, that can be configured to receive operator input. For example, the input device can receive inputs corresponding to a machine weight, a towing weight, and a test slope or grade. The computing device 1001 can provide various prompts for receiving input of such information. Based at least in part on the input information, the computing device can calculate the required hydraulic pressure to simulate the associated loads relative to the inputs (e.g., machine weight, towing weight, and test slope or grade). The computing device 1001 can actuate the hydraulic pressure control valves 170 to generate the required hydraulic pressures.

Optionally, the dynamometer 100 can be modular so that it can be packed and shipped. For example, the dynamometer 100 can be disassembled into discrete modules (e.g., first, second, third, and fourth modules 200a,b,c,d) that are each configured to be positioned within a respective standard shipping container having an inside width of 7 feet, 8 inches. Accordingly, in some aspects, the discrete modules can have widths of 7 feet, six inches or less along each side. In some aspects, the first and second modules 200a,b can comprise (or be embodied as) the first and second wheel engagement assembly 3,4, respectively. The third module 200c can comprise the pressure control valves and heat exchangers (with corresponding fans 178). The fourth module 200d can comprise the engine 174, the first hydraulic pump 176, and the second hydraulic pump 180. It is further contemplated that the ramps 1 and platforms 2 can likewise be disassembled for transport. Optionally, the ramps 1 and platforms 2 can be dismantled into components with dimensions that are receivable into said standard shipping containers having an inside width of 7 feet, 8 inches. Such modularity can enable transport to remote locations for testing equipment in the field. Accordingly, a kit can comprise a plurality of modules that are configured to couple together to form the dynamometer. Optionally, at least one module can comprise components that can be assembled to form the ramps 1 and platforms 2, as disclosed herein.

Optionally, some or all of the modules can comprise a respective base support 196. The base support 196 can optionally comprise feet 198 that are adjustable relative to the vertical axis 14 for stabilizing the base support 196.

### Computing Device

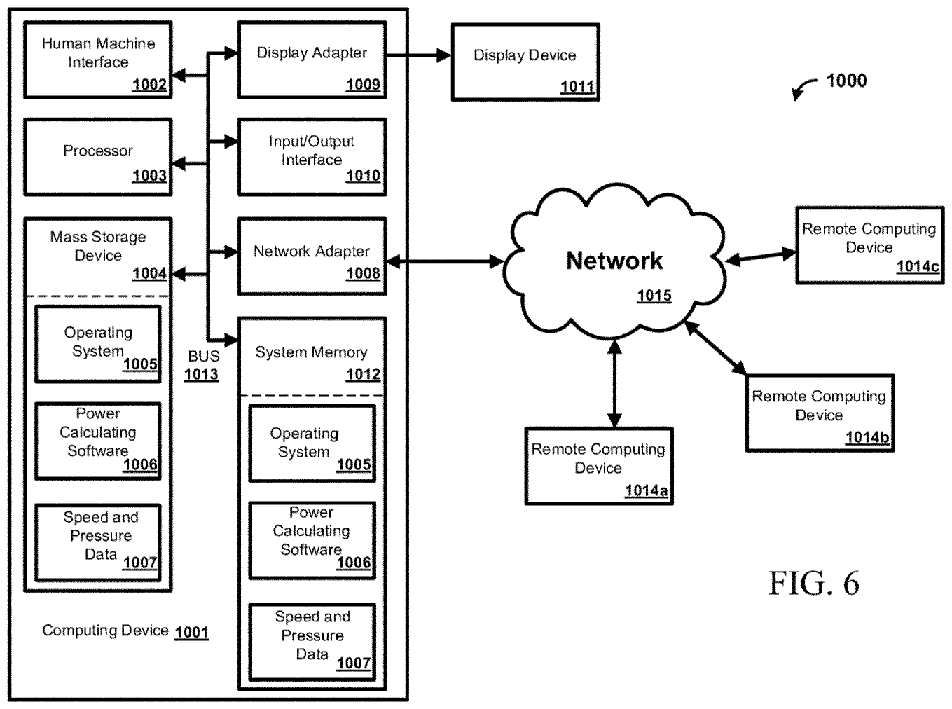

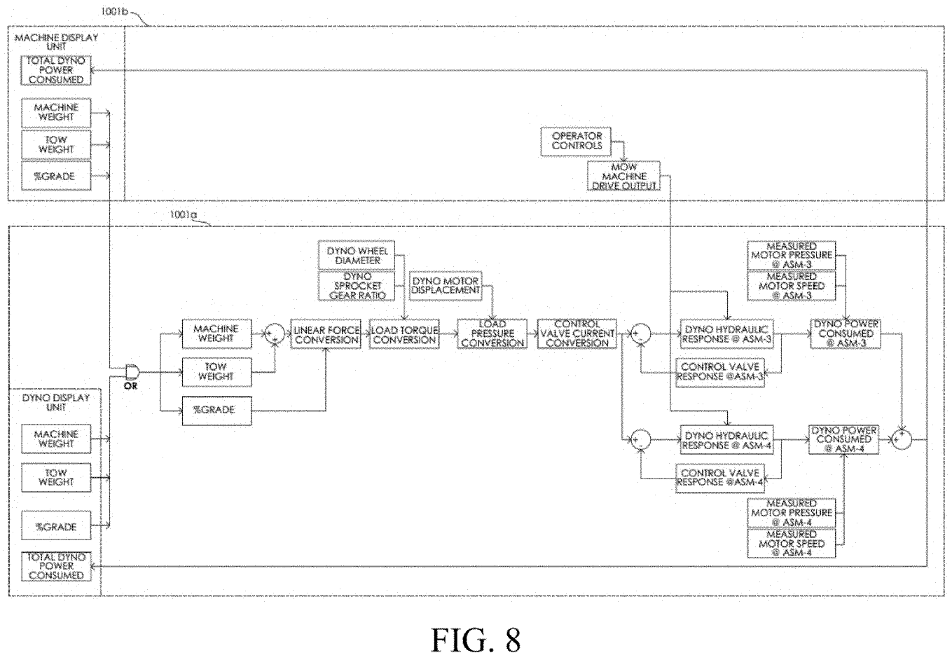

FIG. 6 shows a system 1000 including an exemplary configuration of a computing device 1001. Referring also to FIG. 8, the computing device 1001 can comprise a dyno unit 1001a in communication with a machine unit 1001b. FIG. 8 illustrates an optional embodiment of exemplary control logic for the dynamometer 100. Accordingly, it is contemplated that data input, output, and processing can be performed across various computing devices in communication with each other.

In various aspects, the control system can utilizes J1939 CAN BUS protocol. A J1939 CAN BUS to USB adapter can be used to connect a computing device (e.g., a personal computer to system 1000.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as speed and pressure data 1007 and/or program modules such as operating system 1005 and power calculating software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and power calculating software 1006 may be stored on the mass storage device 1004. One or more of the operating system 1005 and power calculating software 1006 (or some combination thereof) may comprise program modules and the power calculating software 1006. The speed and pressure data 1007 may also be stored on the mass storage device 1004. The speed and pressure data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, touchscreen device, pointing device (e.g., a computer mouse, remote control), a microphone, a joystick, a scanner, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. It is contemplated that at least a portion of the processing can be performed on a cloud computing device. Accordingly, the computing device can be configured with Internet connectivity.

Application programs and other executable program components such as the operating system 1005 are shown herein as discrete blocks, although it is recognized that such programs and components may reside at various times in different storage components of the computing device 1001, and are executed by the one or more processors 1003 of the computing device 1001. An implementation of power calculating software 1006 may be stored on or sent across some form of computer readable media. Any of the disclosed methods may be performed by processor-executable instructions embodied on computer readable media.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, certain changes and modifications may be practiced within the scope of the appended claims.

What is claimed is:

1. A dynamometer for use with rail equipment having two pairs of drive wheels, the dynamometer comprising:
first and second wheel engagement assemblies, each comprising:
a frame;
a first pair of dynamometer wheels that are spaced relative to a first horizontal dimension and rotatably supported on the frame about a first rotational axis that extends parallel to the first horizontal dimension;
a second pair of dynamometer wheels that are spaced relative to the first horizontal dimension and rotatably supported on the frame about a second rotational axis that is parallel to the first horizontal axis and offset from the first horizontal axis relative to a second horizontal dimension that is perpendicular to the first horizontal dimension, wherein the first pair of dynamometer wheels and second pair of dynamometer wheels cooperate to define opposing wheel engagement receptacles;
a hydraulic motor coupled to the first pair of dynamometer wheels, wherein the hydraulic motor is configured to receive a power and an associated torque from a respective pair of the drive wheels of the rail equipment,
wherein the first and second wheel engagement assemblies are configured to move relative to each other along the second dimension.

2. The dynamometer of claim 1, wherein the first and second wheel engagement assemblies are configured to move relative to each other along the first dimension.

3. The dynamometer of claim 2, wherein each of the first and second wheel engagement assemblies is rotatable about a vertical axis.

4. The dynamometer of claim 1, further comprising a plurality of support wheels that are coupled to the frame and are configured to movably support the frame.

5. The dynamometer of claim 4, wherein the support wheels comprise at least one caster.

6. The dynamometer of claim 5, wherein the at least one caster is movably coupled to the frame relative to a vertical axis and is spring biased downwardly relative to the frame.

7. The dynamometer of claim 1, further comprising:
at least one speed sensor coupled to the motor;
at least one pressure control valve in communication with the motor; and
at least one pressure sensor that is configured to determine a hydraulic pressure generated by the motor.

8. The dynamometer of claim 7, further comprising a heat exchanger that is configured to dissipate heat from the at least one pressure control valve.

9. The dynamometer of claim 8, further comprising:
an engine;
a first pump that is configured to receive power from the engine, wherein the first pump is configured to drive a fan that passes air across the heat exchanger; and
a second pump that is configured to receive power from the engine, wherein the second pump is configured to maintain a charge pressure.

10. The dynamometer of claim 9, wherein the dynamometer is modularly defined by a plurality of discrete modules, wherein each of the modules is configured to be received within a shipping crate having a width of 7 feet, 8 inches.

11. The dynamometer of claim 1, wherein the plurality of discrete modules comprises:
a first module comprising the first wheel engagement assembly;
a second module comprising the second wheel engagement assembly;
a third module comprising the at least one pressure control valve and the heat exchanger;
a fourth module comprising the engine.

12. The dynamometer of claim 1, further comprising at least one anchor, wherein the at least one anchor comprises a tie down ring that is coupled to the frame that is configured to couple to a chain.

13. The dynamometer of claim 1, wherein the opposing wheel engagement receptacles are spaced to permit concurrent receipt of respective pairs of drive wheels of the two pairs of drive wheels of the rail equipment.

14. The dynamometer of claim 13, wherein the opposing wheel engagement receptacles are spaced to permit concurrent receipt of drive wheels that are configured for 56.5 inch track gauge.

15. The dynamometer of claim 1, wherein each wheel of the first and second pairs of dynamometer wheels of each of the first and second wheel engagement assemblies defines a respective convex circumferential surface that is receivable into a corresponding groove of a wheel of the rail equipment.

16. The dynamometer of claim 1, wherein the first and second wheel engagement assemblies are collectively able to support at least 150,000 pounds.

17. The dynamometer of claim 1, further comprising a computing device that is configured to:
receive pressure data from the pressure sensor;
receive speed data from the speed sensor; and
calculate a power output by the rail equipment.

18. The dynamometer of claim 17, wherein the computing device is configured to receive, from an input device, a user input comprising at least one of a machine weight, a towing weight, and a test slope or grade; and, based on the user input, calculate a pressure that simulates an associated load corresponding to the at least one user input.

19. The dynamometer of claim 18, wherein the computing device is further configured to cause the at least one pressure control valve to cause the pressure that simulates an associated load corresponding to the at least one user input.

20. The dynamometer of claim 1, further comprising a structure, the structure comprising:
a pair of platforms that are spaced outwardly of the first and second pairs of dynamometer wheels; and
at least one ramp that is configured to provide access to the pair of platforms.
